(19) United States
(12) Patent Application Publication
(10) Pub. No.: US 2014/0124703 A1
(43) Pub. Date: May 8, 2014

(54) BRIGHTNESS OF CE-TB CONTAINING PHOSPHOR AT REDUCED Tb WEIGHT PERCENTAGE

(71) Applicant: Global Tungsten and Powders Corporation, Towanda, PA (US)

(72) Inventor: Chung-Nin Chau, Sayre, PA (US)

(21) Appl. No.: 14/015,593

(22) Filed: Aug. 30, 2013

Related U.S. Application Data
(60) Provisional application No. 61/696,192, filed on Sep. 2, 2012.
(60) Provisional application No. 61/696,194, filed on Sep. 2, 2012.
(60) Provisional application No. 61/696,195, filed on Sep. 2, 2012.
(60) Provisional application No. 61/730,346, filed on Nov. 27, 2012.
(60) Provisional application No. 61/746,905, filed on Dec. 28, 2012.
(60) Provisional application No. 61/746,920, filed on Dec. 28, 2012.
(60) Provisional application No. 61/746,936, filed on Dec. 28, 2012.

(51) Int. Cl. C09K 11/77

(52) U.S. Cl. CPC C09K 11/7777
USPC 252/301.4 P; 428/402

(57) ABSTRACT

A phosphor material having reduced Tb content is disclosed, together with methods for preparing and using the same.

### CROSS REFERENCE TO RELATED APPLICATIONS

The present application claims priority to U.S. Provisional Patent Applications: 61/696,192, filed on Sep. 2, 2012; 61/696,194, filed on Sep. 2, 2012; 61/696,195, filed on Sep. 2, 2012; 61/730,346, filed on Nov. 27, 2012; 61/746,905, filed on Dec. 28, 2012; 61/746,920, filed on Dec. 28, 2012; and 61/746,936, filed on Dec. 28, 2012, all of which applications are incorporated herein fully by this reference.

### BACKGROUND

1. Technical Field

The present disclosure relates to phosphor materials, together with methods for the manufacture and use thereof.

2. Technical Background

The weight percent of Tb in green phosphors, for example, (La_{1-x-y}CeₓTb_{y})PO₄ (LAP) phosphors, can affect the phosphor cost and the resulting fluorescent lamp price. With decreasing production of rare earth materials in various parts of the world and the increasing cost of Tb₄O₇ used in the production of LAP, it would be advantageous to reduce Tb content in such materials while maintaining acceptable brightness drops in resulting fluorescent lamps.

Thus, there is a need to address the aforementioned problems and other shortcomings associated with traditional green phosphor materials. These needs and other needs are satisfied by the compositions and methods of the present disclosure.

### SUMMARY

In accordance with the purpose(s) of the invention, as embodied and broadly described herein, this disclosure, in one aspect, relates to phosphor materials, together with methods for the manufacture and use thereof.

In one aspect, the present disclosure provides a phosphor material having reduced Tb content that can provide acceptable brightness drops in a fluorescent lamp containing the phosphor.

In another aspect, the present disclosure provides methods for the manufacture of a phosphor having reduced Tb content, as described herein.

The accompanying figures, which are incorporated in and constitute a part of this specification, illustrate several aspects and together with the description serve to explain the principles of the invention.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE FIGURES

The accompanying figures, which are incorporated in and constitute a part of this specification, illustrate several aspects and together with the description serve to explain the principles of the invention.

FIGS. 1A and 1B are schematic illustrations of an exemplary fluorescent lamp envelope and an exemplary compact fluorescence lamp assembly, in accordance with various aspects of the present disclosure.

FIG. 2 illustrates the change in the x color chromaticity coordinate upon reduction of the amount of Tb in a conventional LAP phosphor.

FIG. 3 illustrates the change in y color chromaticity coordinate upon reduction of the amount of Tb in a conventional LAP phosphor.

FIG. 4 illustrates the UV absorption spectrum of GdPO₄, as compared to LaPO₄ and LuPO₄, in accordance with various aspects of the present disclosure.

FIG. 5 illustrates the emission spectrum of Ce overplayed with the absorption spectrum of GdPO4, in accordance with various aspects of the present disclosure.

FIG. 6 illustrates the emission spectrum of GdPO₄ overplayed with the absorption spectrum of a LAP phosphor, in accordance with various aspects of the present disclosure.

FIG. 7 illustrates the relative brightness of LAP phosphor materials, both with and without GdPO₄ present, as the weight percent of Tb is varied, in accordance with various aspects of the present disclosure.

FIG. 8 illustrates the change in the x color chromaticity coordinate of LAP phosphor materials, both with and without GdPO₄ present, as the weight percent of Tb is varied, in accordance with various aspects of the present disclosure.

FIG. 9 illustrates the change in the y color chromaticity coordinate of LAP phosphor materials, both with and without GdPO₄ present, as the weight percent of Tb is varied, in accordance with various aspects of the present disclosure.

FIG. 10 illustrates the UV absorption of GdPO₄, upon partial substituted with La (i.e., La₁₋ₓGdₓ)PO₄, in accordance with various aspects of the present disclosure.

FIG. 11 illustrates the relative brightness of LAP phosphor materials with GdPO₄ having various levels of La substitution, as the level of Tb is varied, in accordance with various aspects of the present disclosure.

FIG. 12 illustrates the relative brightness of LAP phosphor materials with GdPO₄, LaPO₄, and LuPO₄, as the level of Tb is varied, in accordance with various aspects of the present disclosure.

FIG. 13 illustrates the relative brightness of LAP phosphor materials with different metal oxides, as the level of Tb is varied, in accordance with various aspects of the present disclosure.

FIG. 14 illustrates the relative brightness of LAP and CAT phosphor materials containing rare earth oxides, as the level of Tb is varied, in accordance with various aspects of the present disclosure.

FIG. 15 illustrates the relative brightness of LAP and CBT phosphor materials containing rare earth oxides, as the level of Tb is varied, in accordance with various aspects of the present disclosure.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used herein, unless specifically stated to the contrary, the singular forms “a,” “an” and “the” include plural referents unless the context clearly dictates otherwise. Thus, for example, reference to “a filler” or “a solvent” includes mixtures of two or more fillers, or solvents, respectively.

As used herein, unless specifically stated to the contrary, the abbreviation “phr” is intended to refer to parts per hundred, as is typically used in the plastics industry to describe the relative amount of each ingredient in a composition.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or can not occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

As used herein, the term “100 hr brightness” is intended to refer to the percentage of brightness maintained after 100 hours of lamp operation. The 100 hr brightness can be determined by dividing the light output of a lamp after 100 hours of operation by the initial light output, and multiplying the result by 100.

As used herein, the term LAP is intended to refer to (La_{1-x-y}CeₓTb_{y})PO₄.

It should be understood that when a reference is made to one type or composition of phosphor, other phosphors or blends of phosphors suitable for use in the invention and not contrary to the effect described can be used. Similarly, references to a rare earth phosphate, a metal phosphate, or a metal oxide are intended to refer to other rare earth phosphates, metal phosphates, or metal oxides unless such use would be inoperable or contrary to the expected effect or desired result.

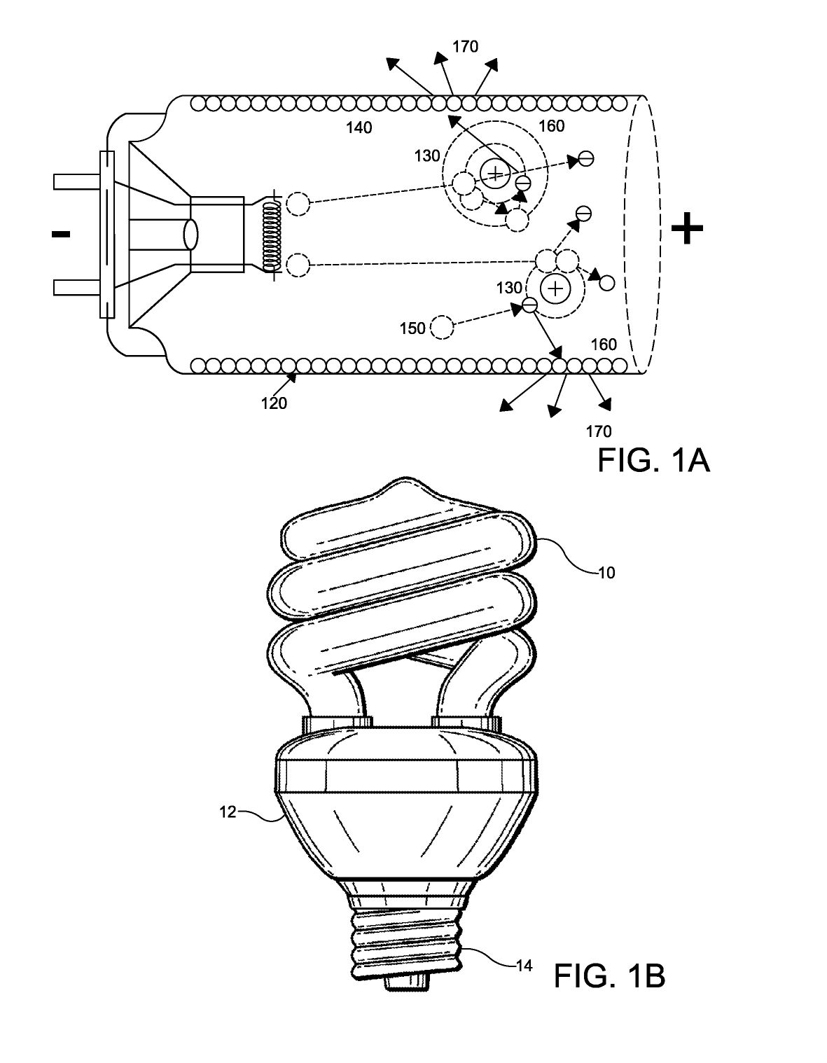

In one aspect, this disclosure provides a lamp assembly or fluorescent lamp comprising the inventive phosphor composition. As used herein, lamp assembly or fluorescent lamp can be used interchangeably. Many styles and designs of fluorescent lamps exist, and the present invention is not intended to be limited to any particular style or design of lamp. In general, a fluorescent lamp comprises an electron source, mercury vapor, a noble gas, and a phosphor or blend of phosphor materials on the interior surface of a sealed envelope. In one aspect, the lamp assembly comprises a fluorescent lamp assembly, a compact fluorescent lamp assembly, or a combination thereof. An exemplary fluorescent lamp assembly is depicted in FIG. 1A. When an electrical current is applied to the electron source, such as tungsten electrodes, electrons are emitted, exciting 140 the noble gas molecules and colliding with mercury atoms 130 inside the lamp (i.e., ionization 150). The collisions temporarily bump the electrons to a higher energy level, after which they return to their lower energy level by emitting UV radiation, for example, at 185 nm and 254 nm. The phosphor or blend of phosphor materials 120 can absorb the UV radiation 160 and emit visible light 170. Similarly, an exemplary compact fluorescent lamp is illustrated in FIG. 1B, wherein the fluorescent envelope 10 is attached to a ballast 12, and wherein the lamp assembly has a screw base 14 for use in conventional light fixtures.

In one aspect, the composition can combined with other phosphor blends. As a non-limiting example, the composition can be a component in a tri-band phosphor blend. As used herein, a tri-band phosphor blend comprises a red emission phosphor, such as, for example, Y₂O₃:Eu (YOE) or Gd₂O₃:Eu (GOE), a green emission phosphor, such as, for example, (LaCeTb)PO₄ (LAP), (CeTb)MgAl₁₁O₁₉ (CAT), or (GdCeTb)MgB₅O₁₀ (CBT), and a blue emission phosphor, such as, for example, (BaEu)MgAl₁₀O₁₇ (BAM) or (SrCaEu)₅(PO₄)₃Cl (SCAP). Further, tri-band phosphor blend and tri-band phosphor layer can be used interchangeably.

In various aspects, many fluorescent lamps utilize a tri-band phosphor layer that comprises one or more red emission phosphors, one or more green emission phosphors, and one or more blue emission phosphors. While specific phosphors and phosphor combinations are specifically recited herein, the invention is intended to include any suitable phosphor or combination of phosphors in combination with a rare earth oxide, as described in the detailed description, claims, examples, and figures that follow. A blend of red, green, and blue emitting phosphor materials, or a layer comprising red, green, and blue emitting phosphors can be used to generate white light having a color temperature of from about 2,700K to about 6,500K. In another aspect, a tri-band blend of phosphors can also contain a fourth component, such as for example, a blue/green emitting component. Blue/green emitting components can, in various aspects, provide lamps having high Ra values.

As briefly described above, the present disclosure provides a composition and methods comprising one or more phosphor materials comprising (LaCeTb)PO₄ and a rare earth phosphate, a metal phosphate, a metal oxide, or a combination thereof.

As global supplies of rare earth metals, such as, for example, Eu₂O₃ and Tb₄O₂, are limited, the cost and availability of these materials can be subject to market demands and fluctuations. In particular, terbium and europium are commonly used in phosphor materials for fluorescent lamps. It would therefore be advantageous to decrease the amount of terbium and/or europium required for fluorescent lamps. Unfortunately, reducing the terbium and/or europium content in a conventional fluorescent lamp results in an undesirable decrease in lamp brightness and can also affect the color output of the lamp.

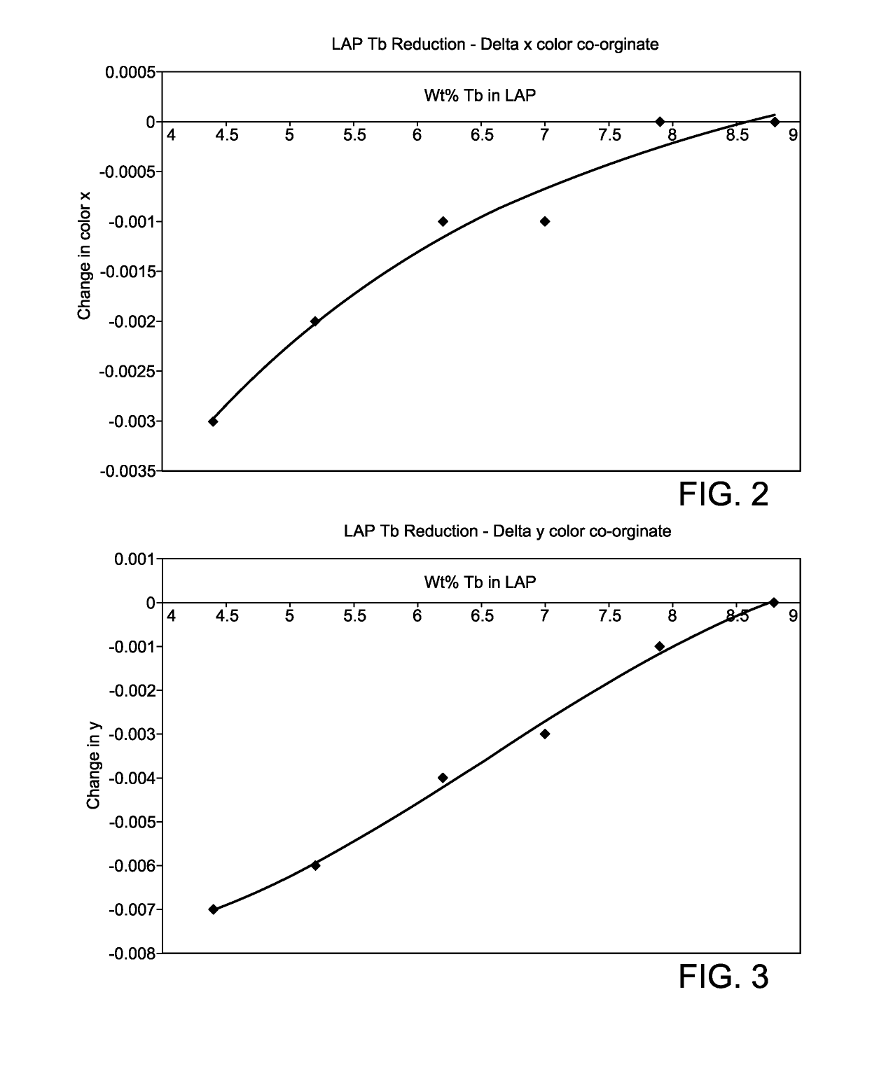

For example, as detailed in Example 1, reduction in the amount of Tb in a single phase LAP phosphor (e.g., [La_{1-x-y}CeₓTb_{y}]PO₄, where 0.2<x<0.6 and 0.05<y<0.1), resulted in a significant drop in brightness. In one aspect, this drop in brightness can be at least partially attributed to a decrease in the energy transfer from Ce to Tb. While the amount of energy transferred from UV radiation incident on the phosphor to Ce can remain substantially unchanged, utilization of the UV energy by the Tb present in the phosphor can drop, resulting in an overall loss in energy and brightness. This loss in energy can also result in a color shift of the resulting visible light, such that the emission contains less green light. The change in x and y color coordinates is illustrated in FIGS. 2 and 3.

Thus, reducing the amount of Tb in a conventional phosphor blend, without any additional changes, can result in an undesirable drop in lamp brightness and potential undesirable color shifts in the light output.

In one aspect, the present disclosure provides compositions and methods for reducing the amount of Tb in a phosphor blend, while maintaining or improving the light output. In another aspect, the present disclosure provides a composition having reduced Tb content, wherein the blend does not exhibit an undesirable color shift from the reduced Tb content.

In one aspect, the one or more phosphor material has a reduced Tb content that can provide a desirable level of brightness drop when utilized in a fluorescent lamp. In another aspect, the present disclosure provides compositions and methods for reducing the amount of Tb in a composition, while maintaining or improving the light output. In a further aspect, the one or more phosphor materials comprise a green-emitting component.

In one aspect, a rare earth phosphate, a metal phosphate, and/or a metal oxide can be added to the composition. In still another aspect, alumina can be used as a pre-coat, prior to or simultaneously with one or more phosphor materials.

The rare earth phosphate, metal phosphate, and/or metal oxide of the present disclosure can be contacted with one or more phosphor materials in any suitable manner. In one aspect, the rare earth phosphate, metal phosphate, and/or metal oxide can be contacted with or mixed with one or more components in the composition. In another aspect, the rare earth phosphate, metal phosphate, and/or metal oxide can be mixed with the composition so as to provide a uniform or substantially uniform mixture of the materials. In another aspect, the rare earth phosphate, metal phosphate, and/or metal oxide can be applied as a separate layer that will be in contact with one or more components of one or more phosphor materials in a lamp assembly. In yet another aspect, the rare earth phosphate, metal phosphate, and/or metal oxide can be applied to, for example, a portion of the interior envelope of a lamp assembly as a pre-coat layer, prior to application of a tri-band layer. In still other aspects, other coating techniques and methods known in the art can be used, provided that at least a portion of the rare earth phosphate, metal phosphate, and/or metal oxide is in contact with at least a portion of the tri-band phosphor blend.

In various aspects, the red, green, and blue emitting portions of the tri-band phosphor can comprise any individual or mixture of phosphor materials as recited herein or that one of skill in the art could readily select. It should be noted that tri-band phosphors and the individual phosphors that can form a tri-band blend are commercially available, and that one of skill in the art, in possession of this disclosure, could readily select an appropriate phosphor or blend of phosphors. In one aspect, the tri-band phosphor blend comprises one or more red emitting phosphors, one or more green emitting phosphors, and one or more blue emitting phosphors. In one aspect, the red emitting phosphor can comprise YOE, GOE, or a combination thereof. In another aspect, the green emitting phosphor can comprise LAP, CAT, CBT, or a combination thereof. In yet another aspect, the blue emitting phosphor can comprise BAM, SCAP, or a combination thereof. Similarly, rare earth phosphates, metal phosphates, and metal oxides are commercially available.

### Rare Earth Phosphate, Metal Phosphate, or Metal Oxide

In one aspect, the invention comprises contacting a rare earth phosphate with one or more phosphor materials comprising (LaCeTb)PO₄. In one aspect, a rare earth phosphate, if used, can comprise any rare earth phosphate suitable for use in the present invention. In another aspect, the rare earth phosphate, if used, can comprise LaPO₄, GdPO₄, LuPO₄, (La₁₋ₓGdₓ)PO₄, YPO₄, or a combination thereof. In another aspect, the rare earth phosphate, if used, can comprise any one or more additional rare earth phosphates not specifically recited herein, either in addition to or in lieu of any one or more rare earth phosphates listed above. In another aspect, the rare earth phosphate, if used, comprises an unactivated rare earth phosphate. In another aspect, the rare earth phosphate comprises GdPO₄. In still another aspect, the invention comprises contacting a rare earth phosphate with one or more phosphor materials comprising (LaCeTb)PO₄, wherein at least one or more of the components of the one or more phosphor materials comprising (LaCeTb)PO₄ have a reduced content of Tb.

In another aspect, the invention comprises contacting a metal phosphate with one or more phosphor materials comprising (LaCeTb)PO₄. In one aspect, a metal phosphate, if used, can comprise any metal phosphate suitable for use in the present invention. In another aspect, the metal phosphate, if used, can comprise BiPO₄ or AlPO₄, or a combination thereof. In another aspect, the metal phosphate, if used, can comprise any one or more additional metal phosphates not specifically recited herein, either in addition to or in lieu of any one or more metal phosphates listed above. In another aspect, the metal phosphate, if used, comprises an unactivated metal phosphate. In still another aspect, the invention comprises contacting a metal phosphate with one or more phosphor materials comprising (LaCeTb)PO₄, wherein the one or more phosphor materials comprising (LaCeTb)PO₄ have a reduced content of Tb.

In another aspect, the invention comprises contacting a metal oxide with one or more phosphor materials comprising (LaCeTb)PO₄. In one aspect, a metal oxide, if used, can comprise any metal oxide suitable for use in the present invention. In another aspect, the metal oxide, if used, can comprise Al₂O₃, Y₂O₃, La₂O₃, Ta₂O₅, Nb₂O₅, or Gd₂O₃, or a combination thereof. In another aspect, the metal oxide, if used, can comprise any one or more additional metal oxides not specifically recited herein, either in addition to or in lieu of any one or more metal oxides listed above. In one aspect, the invention can comprise Al₂O₃. In another aspect, the invention can comprise Y₂O₃. In another aspect, the invention can comprise La₂O₃. In another aspect, the invention can comprise Ta₂O₅. In another aspect, the invention can comprise Nb₂O₅. In another aspect, the invention can comprise Gd₂O₃. In still another aspect, the invention comprises contacting a metal oxide with one or more phosphor materials comprising (LaCeTb)PO₄, wherein the one or more phosphor materials comprising (LaCeTb)PO₄ have a reduced content of Tb. In yet other aspects, the invention can comprise a one or more phosphor materials comprising (LaCeTb)PO₄ and one or more of a rare earth phosphate, a metal phosphate, a metal oxide, or a combination thereof.

In one aspect, the addition of a rare earth phosphate, a metal phosphate, a metal oxide, or a combination thereof with one or more phosphor materials comprising (LaCeTb)PO₄, can result in minimum brightness loss results over a large range of Tb reductions, as compared to a similar composition not comprising the rare earth phosphate, metal phosphate, metal oxide, or combination thereof. In another aspect, GdPO₄ is contacted with or added to one or more phosphor materials comprising (LaCeTb)PO₄, such that a minimum brightness loss results over a large range of Tb reductions, as compared to a similar composition not comprising the GdPO₄.

In various aspects, the amount of rare earth phosphate, metal phosphate, metal oxide, or a combination thereof, can vary depending upon the specific phosphor materials and desired properties of the resulting product, and one of skill in the art, in possession of this disclosure, could readily select an appropriate concentration for a given phosphor or phosphor blend and application. In one aspect, a rare earth phosphate, metal phosphate, metal oxide, or a combination thereof can be present at a level of from about 0.01 wt. % to about 50 wt. %, for example, about 0.01, 0.02, 0.05, 0.1, 0.2, 0.3, 0.5, 0.8, 1, 1.5, 2, 2.5, 3, 4, 5, 7, 8, 10, 12, 14, 16, 18, 20, 22, 24, 26, 28, 30, 32, 34, 36, 38, 40, 42, 44, 46, 48, or 50 wt. %. In another aspect, a rare earth phosphate, metal phosphate, metal oxide, or a combination thereof can be present at a level of from about 0.01 wt. % to about 25 wt. %, for example, about 0.01, 0.03, 0.05, 0.07, 0.1, 0.3, 0.5, 0.7, 0.9, 1, 1.3, 1.5, 1.7, 1.9, 3, 5, 7, 9, 11, 13, 15, 17, 19, 21, 23, or 25 wt. %. In another aspect, a rare earth phosphate, metal phosphate, metal oxide, or a combination thereof can be present at a level of from about 0.01 wt. % to about 15 wt. %, for example, about 0.01, 0.03, 0.05, 0.07, 0.1, 0.3, 0.5, 0.7, 0.9, 1, 1.3, 1.5, 1.7, 1.9, 3, 5, 7, 9, 11, 13, or 15 wt. %. In still other aspects, a rare earth phosphate, metal phosphate, metal oxide, or a combination thereof can be present at a level of from about 1, 2, 4, 6, 8, 10, or 12 wt. %. In one aspect, GdPO₄ can be present at a level of from about 0.01 wt. % to about 50 wt. %, for example, about 0.01, 0.02, 0.05, 0.1, 0.2, 0.3, 0.5, 0.8, 1, 1.5, 2, 2.5, 3, 4, 5, 7, 8, 10, 12, 14, 16, 18, 20, 22, 24, 26, 28, 30, 32, 34, 36, 38, 40, 42, 44, 46, 48, or 50 wt. %; at a level of from about 0.01 wt. % to about 30 wt. %, for example, about 0.01, 0.02, 0.05, 0.1, 0.2, 0.3, 0.5, 0.8, 1, 1.5, 2, 2.5, 3, 4, 5, 7, 8, 10, 12, 14, 16, 18, 20, 22, 24, 26, 28, or 30 wt. %; at a level of from about 0.01 wt. % to about 25 wt. %, for example, about 0.01, 0.02, 0.05, 0.1, 0.2, 0.3, 0.5, 0.8, 1, 1.5, 2, 2.5, 3, 4, 5, 7, 8, 10, 12, 14, 16, 18, 20, 22, 24, or 25 wt. %; or at a level of from about 0.01 wt. % to about 20 wt. %, for example, about 0.01, 0.02, 0.05, 0.1, 0.2, 0.3, 0.5, 0.8, 1, 1.5, 2, 2.5, 3, 4, 5, 7, 8, 10, 12, 14, 16, 18, or 20 wt. %, of a single phosphor, for example, LAP, a blend of phosphors, or one or more phosphor materials.

In one aspect, a rare earth phosphate, metal phosphate, metal oxide, or a combination thereof can be present in a LAP phosphor at a level of up to about 60 wt. %, for example, about 0, 1, 2, 3, 4, 5, 7, 9, 12, 14, 16, 18, 20, 22, 24, 26, 28, 30, 32, 34, 36, 38, 40, 42, 44, 46, 48, 50, 52, 54, 56, 58, or 60 wt. %; up to a level of about 40 wt. %, for example, about 0, 2, 4, 6, 8, 10, 12, 14, 16, 18, 20, 22, 24, 26, 28, 30, 32, 34, 36, 38, or 40 wt. %, or up to a level of about 20 wt. %, for example, about 0, 2, 4, 6, 8, 10, 12, 14, 16, 18, or 20 wt. %. In yet another aspect, a rare earth phosphate, metal phosphate, metal oxide, or a combination thereof can be present in a LAP phosphor at a level of from about 20 wt. % to about 40 wt. %, for example, about 20, 22, 24, 26, 28, 30, 32, 34, 36, 38, or 40 wt. %. In yet another aspect, GdPO₄ can be present in a LAP phosphor at a level of from about 20 wt. % to about 40 wt. %, for example, about 20, 22, 24, 26, 28, 30, 32, 34, 36, 38, or 40 wt. %.

In one aspect, the presence of the rare earth phosphate can reduce the phosphor's activator content and/or reduce the concentration of activator needed to maintain a desirable brightness. Such a resulting phosphor or phosphor blend having a reduced activator content can exhibit a reduced change in color, as compared to a similar phosphor or phosphor blend prepared with lower activator content via a direct synthesis method (e.g., not comprising the rare earth phosphate). In another aspect, improved brightness can be achieved for phosphors having reduced activator content, over direct synthesis methods, by contacting LaPO₄, GdPO₄, or a combination thereof with one or more phosphor components by, for example, blending, coating, and/or firing the phosphor mixture after contacting with the LaPO₄, GdPO₄, or a combination thereof.

In another aspect, while LaPO₄ can provide improved performance, the presence of GdPO₄, in addition to or in lieu of LaPO₄, can provide a further improvement in performance at reduced activator levels when contacted with a green emitting phosphor.

In one aspect, a rare earth phosphate, metal phosphate, metal oxide, or a combination thereof can be present in the composition at a level of up to about 60 wt. %, for example, about 0, 1, 2, 3, 4, 5, 7, 9, 12, 14, 16, 18, 20, 24, 28, 32, 36, 40, 44, 48, 52, 56, or 60 wt. %; up to a level of about 50 wt. %, for example, about 0, 2, 4, 6, 8, 10, 12, 14, 15, 20, 25, 30, 35, 40, 45, or 50 wt. %, or up to a level of about 30 wt. %, for example, about 0, 2, 4, 6, 8, 10, 12, 14, 16, 18, 20, 22, 24, 26, 28, or 30 wt. %. In yet another aspect, a rare earth phosphate, metal phosphate, metal oxide, or a combination thereof can be present in the composition at a level of from about 50 wt. % to about 60 wt. %, for example, about 50, 52, 54, 56, 58, or 60 wt. %. In yet another aspect, GdPO₄ can be present in a tri-band phosphor blend at a level of from about 10 wt. % to about 30 wt. %, for example, about 10, 12, 14, 16, 18, 20, 22, 24, 26, 28, or 30 wt. %.

Upon addition of a rare earth phosphate, metal phosphate, metal oxide, or a combination thereof, a reduction in Tb content can be achieved without any significant loss in brightness. In one aspect, the addition of a rare earth phosphate, metal phosphate, metal oxide, or a combination thereof can allow for a reduction in Tb of up to about 2 wt. %, up to about 5 wt. %, up to about 10 wt. %, up to about 15 wt. %, up to about 25 wt. %, up to about 30 wt. %, or more, without a significant decrease in brightness.

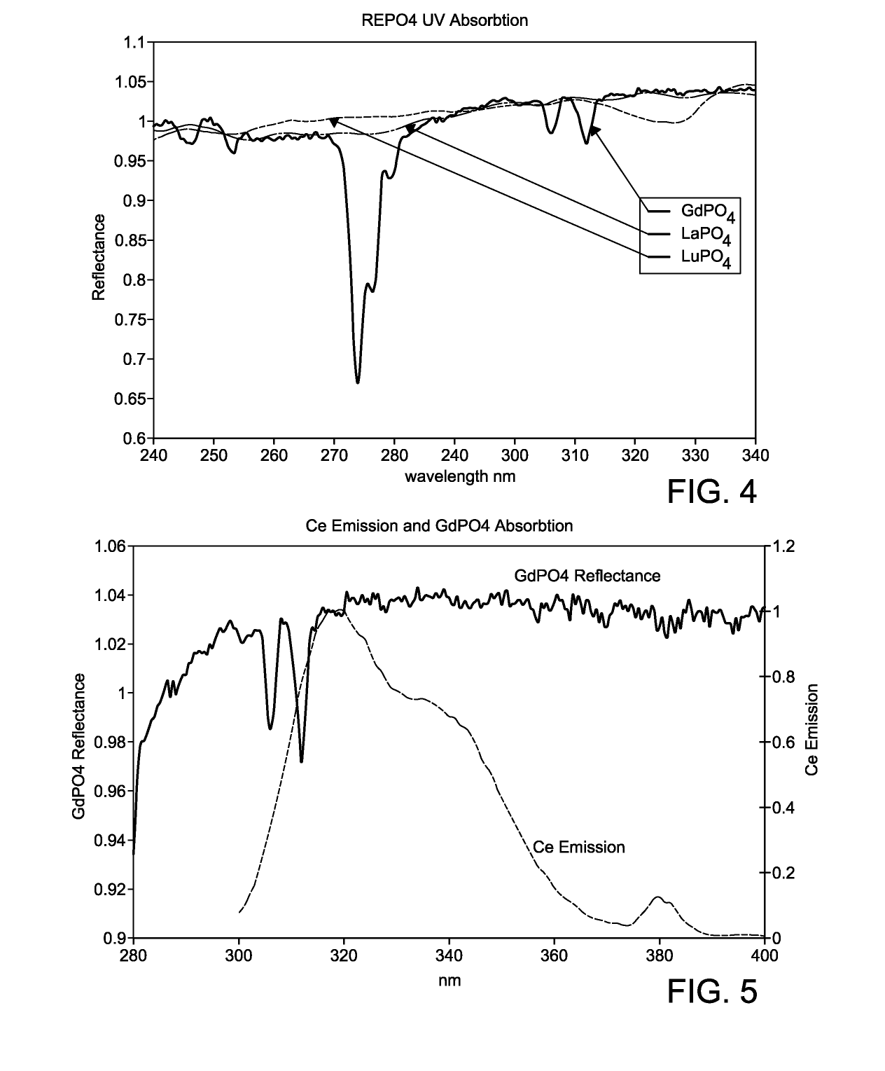

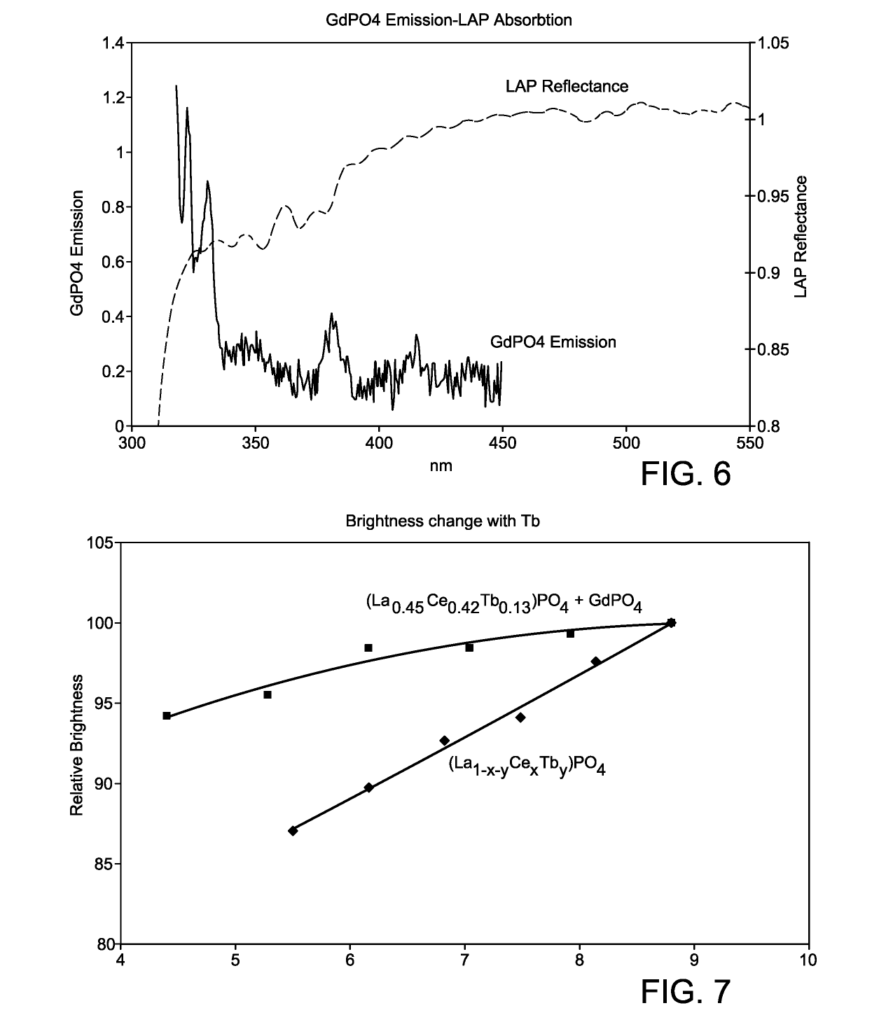

In one aspect, GdPO₄, if used, can absorb both the 254 nm Hg line emission and the 319 nm emission from Ce in the composition. FIG. 4 illustrates visible absorption spectra for GdPO₄, LaPO₄, and LuPO₄. FIG. 5 illustrates the visible Ce emission profile and the overlapping GdPO₄ absorption peaks. GdPO₄ also has emission peaks at 330 nm and 380 nm where Ce can absorb, as illustrated in FIG. 6. While not wishing to be bound by theory, these absorption and emission properties can enable a theoretically possible Gd³⁺ sublattice sensitization and activation effect wherein Ce³⁺ excitation energy can be transferred to the Gd³⁺ sublattice. Such an effect can be observed in a CBT (GdMgB₅O₁₀:Ce:Tb) phosphor system. Since Gd³⁺ to Gd³⁺ jumps can be many times faster than Ce³⁺ to Ce³⁺ transfers (e.g., about 10¹¹ s⁻¹, compared to the even slower Ce³⁺ to Tb³⁺ transfer of 3×10⁸ s⁻¹), this can reduce the energy loss mechanism typical for a slower energy transfer process. Thus, in one aspect, the overall result from having a Gd³⁺ sublattice effect is the ability to covert more ultraviolet radiation into visible light, or less energy lost.

In one aspect, the transfer of energy in a tri-band phosphor blend comprising GdPO₄ can be illustrated as:

Excitation→Ce³⁺→Gd³⁺ [symbol] Gd³⁺Tb³⁺→Emission (1).

To illustrate this effect, the relative brightness of LAP phosphor materials was determined for both LAP phosphors with and without GdPO₄, as the amount of Tb was varied. FIG. 7 illustrates the significantly reduced brightness loss over a range of Tb levels for the sample comprising GdPO₄, whereas the LAP phosphor without GdPO₄ exhibited a substantial brightness loss as the Tb level decreased.

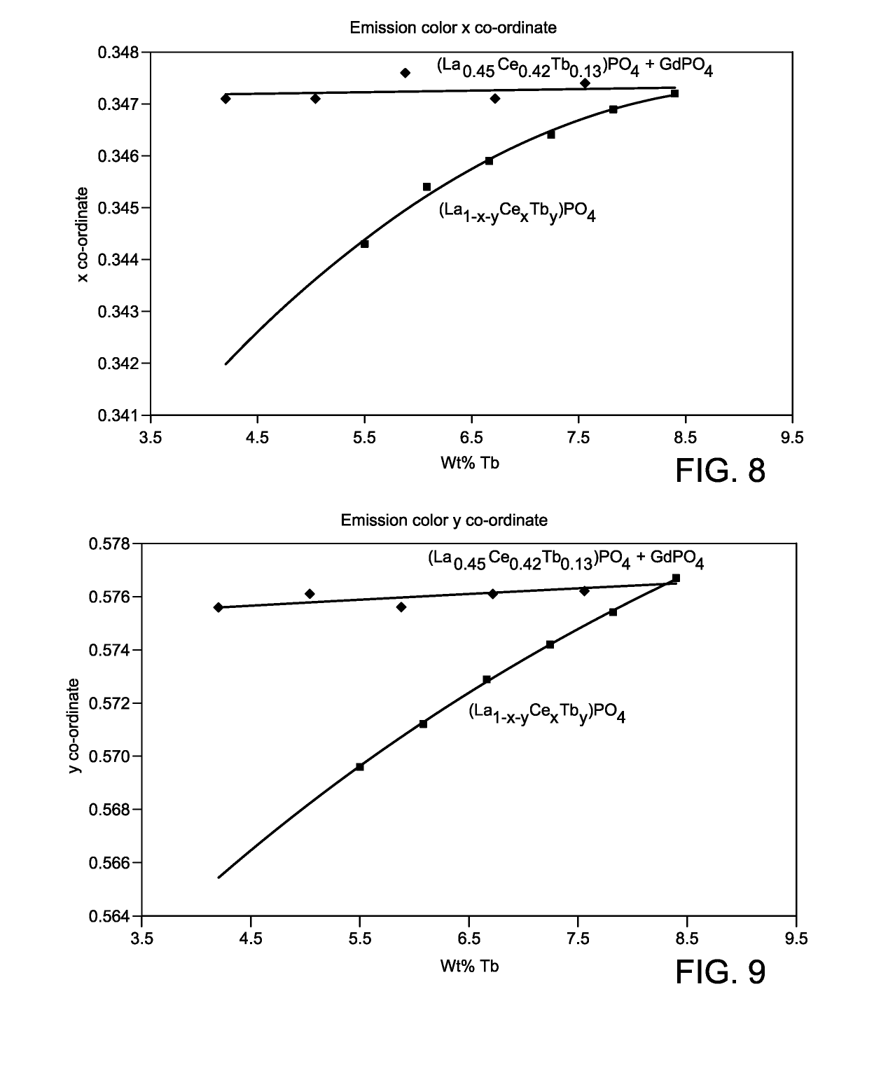

In another aspect, the addition of a rare earth phosphate, metal phosphate, metal oxide, or a combination thereof, can reduce or eliminate the color shift in light output otherwise observed if the Tb content is varied. FIGS. 8 and 9 illustrate the x color coordinate and y color coordinate changes for both LAP phosphors with and without GdPO₄, as the amount of Tb was varied. Thus, when GdPO₄ is added to the one or more phosphor materials comprising (LaCeTb)PO₄, the resulting combination can maintain at least about 90%, at least about 92%, or at least about 94% of the relative brightness, even upon a reduction of up to 50% in the amount of Tb present in the LAP phosphor (e.g., a reduction of from about 9 wt. % to about 4.5 wt. %). Similarly, the addition of GdPO₄ to one or more phosphor materials comprising (LaCeTb)PO₄ can result in substantially little color shift, for example, a change in the x color coordinate of less than about 0.001 for a reduction in Tb level of from about 8.5 wt. % to about 4.5 wt. %, as compared to a change of about 0.005 for a comparable sample not comprising GdPO₄; and a change in the y color coordinate of less than about 0.001 for a reduction in Tb level of from about 8.5 wt. % to about 4.5 wt. %, as compared to a change of about 0.010 for a comparable sample not comprising GdPO₄).

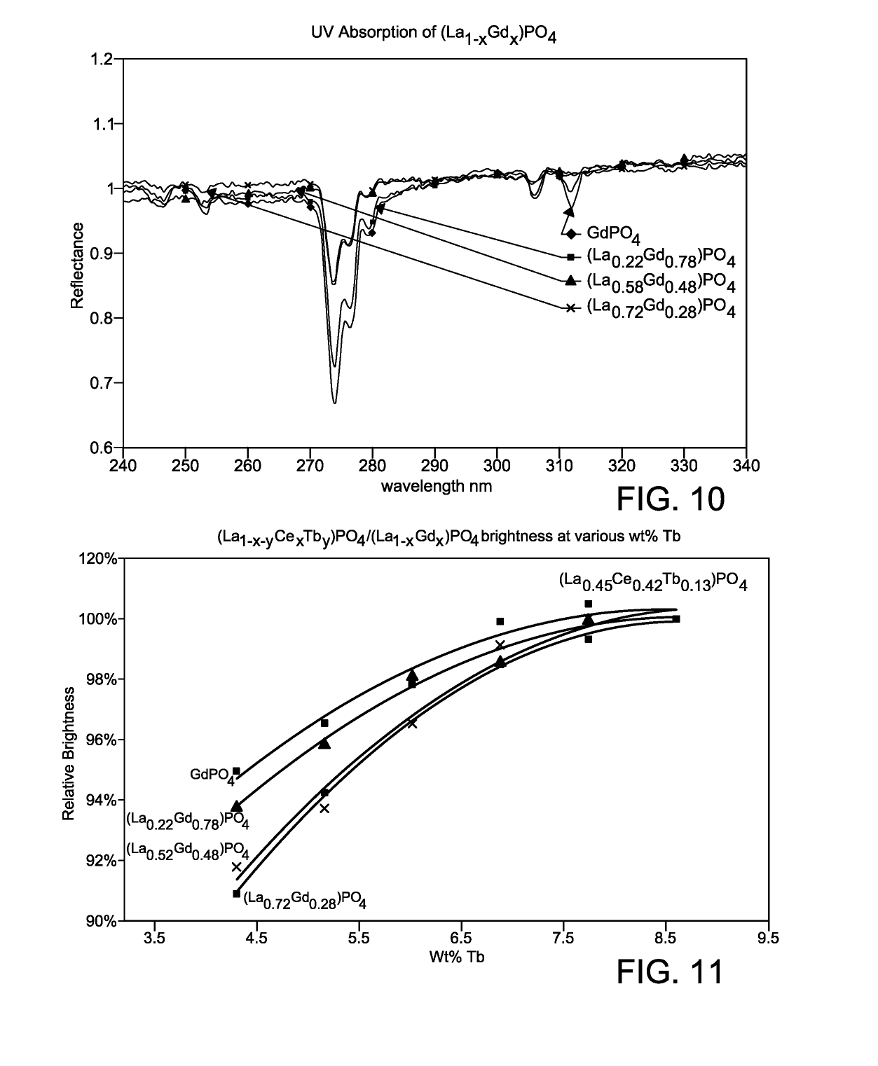

In yet another aspect, all of a portion of the Gd in GdPO₄, if used, can be at least partially substituted with La, for example, in a (Gd₁₋ₓLaₓ)PO₄ solid solution matrix. While not wishing to be bound by theory, it is believed that substitution of a portion of the Gd with La can interrupt the Gd³⁺ sublattice. While the benefit of the GdPO₄ addition can be reduced upon substitution with La, a La substituted GdPO₄ can still exhibit a greater retention of brightness than a comparable single phase LAP phosphor without GdPO₄ or substituted GdPO₄ present. Thus, in one aspect, at least a portion of the GdPO₄ can be substituted with La. In another aspect, GdPO₄ can be substituted with La at a level up to about 40 wt. %, for example, about 0, 2, 4, 6, 8, 10, 12, 14, 16, 18, 20, 22, 24, 26, 28, 30, 32, 34, 36, 38, or 40 wt. %; or up to about 30 wt. %, for example, about 0, 2, 4, 6, 8, 10, 12, 14, 16, 18, 20, 22, 24, 26, 28, or 30 wt. %. In another aspect, GdPO4 can be substituted with La at a level of from about 30 wt. % to about 40 wt. %, at a level of from about 0.1 wt. % to about 30 wt. %, at a level of from about 2 wt. % to about 25 wt. %, or at a level of from about 1 wt. % to about 20 wt. %. FIG. 10 illustrates the UV absorption spectra of GdPO₄ with varying levels of La substitution. Even at a substitution level of La_{0.72}Gd_{0.28}, the UV absorption peak is clearly visible. Similarly, FIG. 11 illustrates the relative brightness of LAP phosphor samples with GdPO₄ and substituted (La₁₋ₓGdₓ)PO₄ present, where the level of Tb is varied. While the relative brightness for samples with La substituted GdPO₄ was lower than that for samples having unsubstituted GdPO₄, the relative brightness for the substituted samples was still acceptable for most applications. Moreover, the reduction in brightness with substituted GdPO₄ was still better than for single phase samples not comprising GdPO₄ or a substituted GdPO₄.

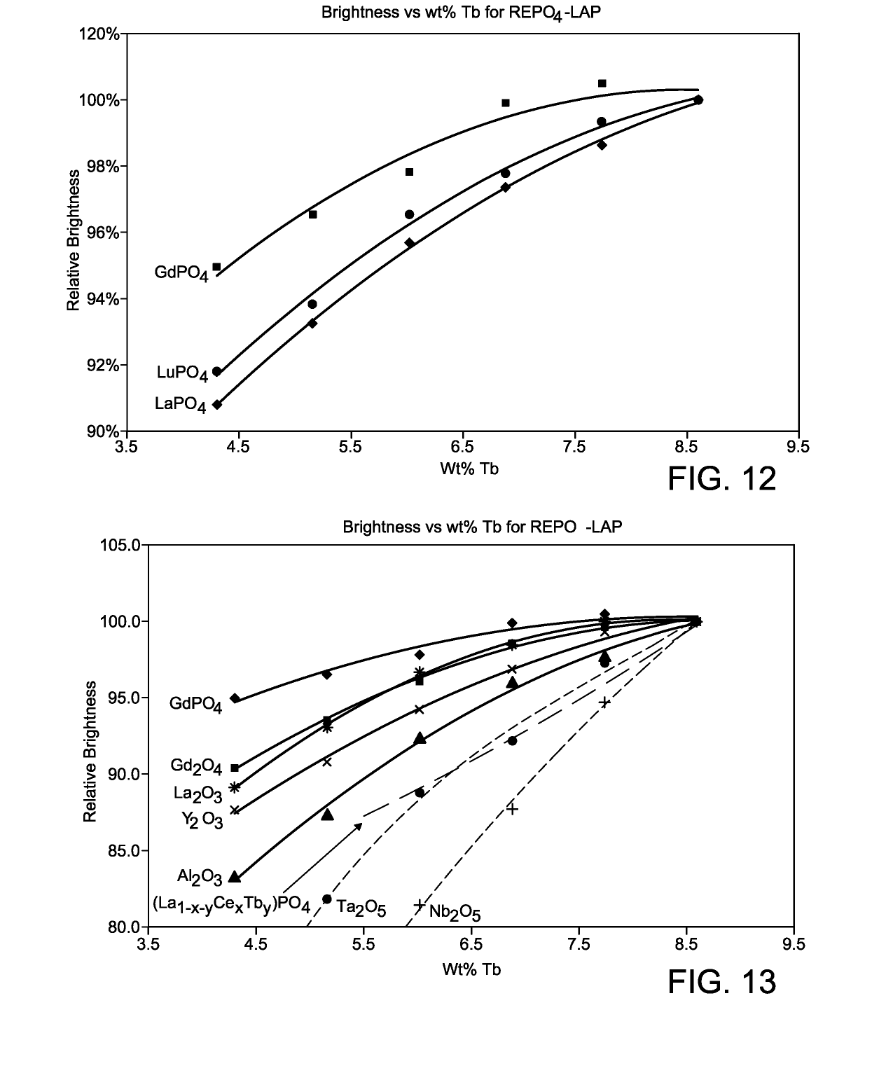

In still another aspect, the combination of other phosphates or oxide compounds with a LAP phosphor can provide improved retention of brightness, although at potentially reduced levels of retention than for GdPO₄ containing samples, as illustrated in FIG. 12 for GdPO₄, LuPO₄, and LaPO₄. In one aspect, the use of such phosphates and oxides in LAP systems can provide a brightness drop less than that observed from Tb reduction in a single phase (La_{1-x-y}CeₓTb_{y})PO₄. FIG. 13 further illustrates this benefit and effect for the metal oxides: GdPO₄, Gd₂O₃, La₂O₃, Y₂O₃, Al₂O₃, Ta₂O₅, and Nb₂O₅, as compared to a LAP phosphor alone.

In one aspect, addition of GdPO₄ can allow a retention of at least about 95% of brightness, as compared to a convention phosphor without GdPO₄, or without a rare earth phosphate, metal phosphate, or metal oxide, at a Tb level of about 3.4 wt. % or less, for example, about 2.5, 2.75, 3, 3.1, 3.2, 3.3, or 3.4 wt. %; or a retention of at least about 98% of brightness at a Tb level of about 4 wt. % of less, for example, about 2.5, 2.75, 3, 3.25, 3.5, 3.75, 3.8, 3.9, 3.92, 3.94, 3.96, 3.98, or 4 wt. %; or a retention of about 100% of brightness at a Tb level of about 6 wt. % or less, for example, about 4, 4.25, 4.5, 4.75, 5, 5.25, 5.5, 5.75, or 6 wt. %, or at a Tb level of from about 5.75 wt. % or less, for example, about 5, 5.2, 5.25, 5.3, 5.35, 5.4, 5.45, 5.5, 5.6, or 5.65 wt. %.

In one aspect, addition of Gd₂O₃ can allow a retention of at least about 90% of brightness, as compared to a convention phosphor without Gd₂PO₃, or without a rare earth phosphate, metal phosphate, or metal oxide, at a Tb level of about 3 wt. % or less, for example, about 2.5, 2.75, 2.8, 2.85, 2.9, 2.95, or 3 wt. %; a retention of at least about 95% of brightness at a Tb level of about 4 wt. % of less, for example, about 2.5, 2.75, 3, 3.25, 3.5, 3.75, 3.8, 3.9, 3.92, 3.94, 3.96, 3.98, or 4 wt. %; or a retention of at least about 98% of brightness at a Tb level of about 5.25 wt. % of less, for example, about 3, 3.5, 3.75, 4, 4.25, 4.5, 4.75, 4.8, 4.9, 4.95, 5, 5.05, 5.1, 5.15, 5.2, or 5.25 wt. %; or a retention of about 100% of brightness at a Tb level of about 6 wt. % or less, for example, about 4, 4.25, 4.5, 4.75, 5, 5.25, 5.5, 5.75, or 6 wt. %, or at a Tb level of from about 5.75 wt. % or less, for example, about 5, 5.2, 5.25, 5.3, 5.35, 5.4, 5.45, 5.5, 5.6, or 5.65 wt. %.

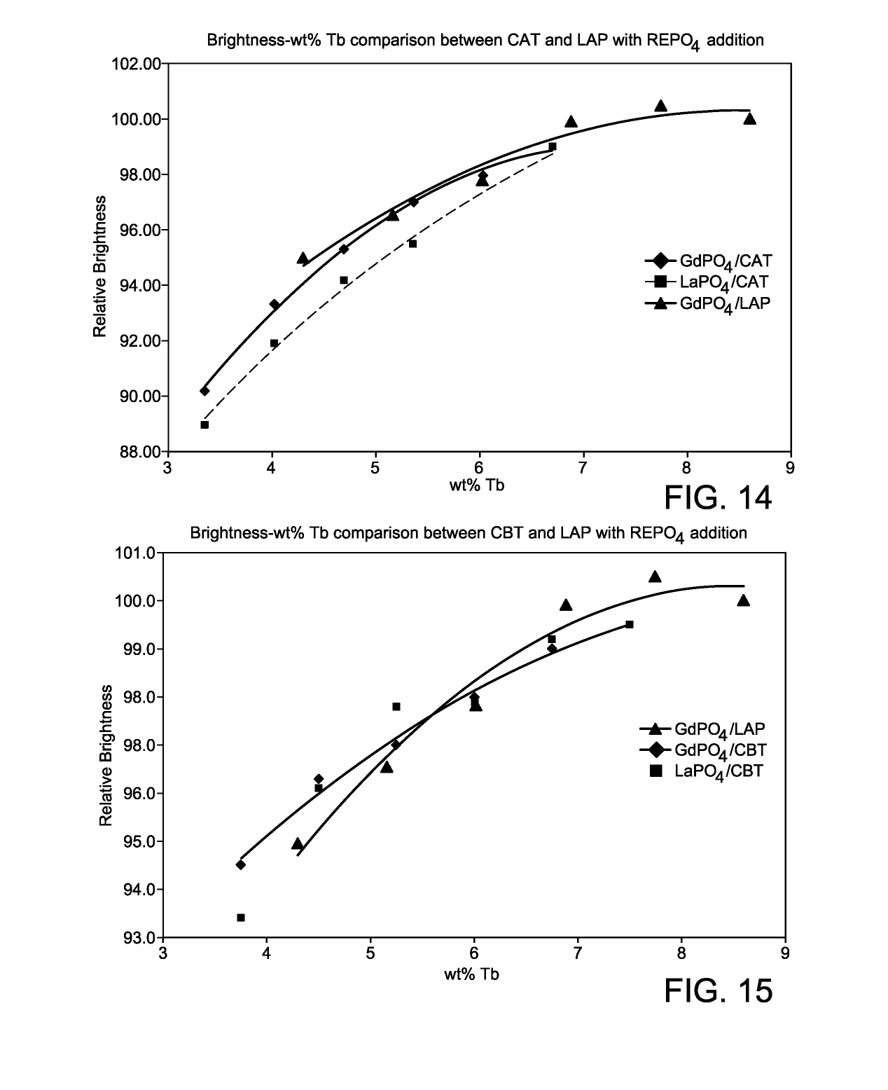

In one aspect, the Gd³⁺ sublattice effect by GdPO₄ described above with respect to LAP phosphors can also be seen with other Ce—Tb containing phosphor such as a green emitting (Ce,Tb)MgAl₁₁O₁₉:Ce:Tb (CAT) phosphor. FIG. 14 illustrates a comparison between a CAT phosphor with GdPO₄, a CAT phosphor with LaPO₄, and a LAP phosphor with GdPO₄, as the Tb level is varied. It should be noted that the intrinsic optimal wt % of Tb in CAT can be lower than LAP, thus making the Tb wt % range extendable lower than that for a LAP/GdPO₄ system.

In another aspect, (GdCeTb)MgB₅O₁₀:Ce:Tb (CBT) phosphors can exhibit a Gd³⁺ sublattice, even without addition of GdPO4, or another rare earth phosphate, metal phosphate, or metal oxide. Accordingly, addition of GdPO₄, LaPO₄, or other materials are not expected to provide a significant improvement to the extent observed in other, for example, LAP, phosphors, as illustrated in FIG. 15. In one aspect, it is believed that the existing internal Gd³⁺ sublattice in a CBT phosphor can provide a benefit at the low end of the Tb wt % range.

In other aspects, the particle size of all or a portion of the phosphor materials in the composition can vary, and the present invention is not intended to be limited to any particular particle size. In another aspect, all or a portion of the phosphor materials can exhibit an average particle size of from about 0.5 μm to about 30 μm, for example, about 0.5, 1, 1.5, 2, 2.5, 3, 4, 5, 7, 9, 11, 13, 15, 17, 19, 21, 23, 25, 27, 29, or 30 μm; of from about 2 μm to about 16 μm, for example, about 2, 3, 4, 5, 6, 7, 8, 9, 10, 11, 12, 13, 14, 15, or 16 μm; from about 2 μm to about 8 μm, for example, about 2, 2.5, 3, 3.5, 4, 4.5, 5, 5.5, 6, 6.5, 7, 7.5, or 8 μm; or from about 4 μm to about 10 μm, for example, about 4, 4.5, 5, 5.5, 6, 6.5, 7, 7.5, 8, 8.5, 9, 9.5, or 10 μm. In a specific aspect, all or a portion of a phosphor material, for example, exhibits an average particle size of about 5 μm.

In another aspect, the rare earth phosphate, metal phosphate, metal oxide, or a combination thereof, can comprise a particle size larger than all or a portion of the phosphor material or blend of phosphor materials. In one aspect, at least a portion of the rare earth phosphate, metal phosphate, metal oxide, or a combination thereof, such as, for example, GdPO₄, can exhibit an average particle size of from about 100% to about 150%, for example, about 100, 102, 104, 106, 108, 110, 112, 114, 116, 118, 120, 125, 130, 135, 140, 145, or 150% of the average particle size of at least one of the phosphor materials. In another aspect, at least a portion of the rare earth phosphate, metal phosphate, metal oxide, or a combination thereof, such as, for example, GdPO₄, can exhibit an average particle size of from about 100% to about 125%, for example, about 100, 102, 104, 106, 108, 110, 112, 114, 116, 118, 120, or 125% of the average particle size of at least one of the phosphor materials. In a specific aspect, the phosphor can comprise an average particle size of about 5 μm, and the rare earth phosphate, metal phosphate, metal oxide, or a combination thereof, such as, for example, GdPO4, can exhibit an average particle size of from about 5 μm to about 7 μm, for example, about 5, 5.5, 6, 6.5, or 7 μm; or from about 5 μm to about 6 μm, for example, about 5, 5.2, 5.4, 5.6, 5.8, or 6 μm; or from about 5.2 μm to about 5.7 μm, for example, about 5.2, 5.3, 5.4, 5.5, 5.6, or 5.7 μm. In a specific aspect, a phosphor material, for example, exhibits an average particle size of about 5 μm and the rare earth phosphate, metal phosphate, metal oxide, or a combination thereof exhibits an average particle size of about 5.5 μm.

In one aspect, any one or more of the components described herein can be provided in a pure or substantially pure form. As used herein, the terms “pure” and “substantially pure” are intended to refer to components that do not comprise large quantities of impurities. In various aspects, substantially pure can refer to components having less than about 500 ppm, less than about 250 ppm, less than about 100 ppm, less than about 75 ppm, less than about 50 ppm, less than about 25 ppm, or less than about 10 ppm of impurities or other contaminants. It should be noted that, in some cases, an element, compound, or species can be present as intended in one component, but can be considered an impurity or contaminant if present in another component, for example, if entrained in the matrix of one component. In another aspect, the presence of impurities, such as, for example, Ce, Tb, and/or Eu, can result in undesirable UV absorption of GdPO₄. For example, in one aspect, an increase in Ce concentration can result in UV absorption around about 254 nm. Such absorption can, in various aspects, result in phosphor blends having reduced brightness. Thus, in one aspect, the level of Ce present is less than about 50 ppm, for example, about 50, 48, 46, 44, 42, 40, 38, 36, 34, 32, 30, 28, 26, 24, 22, 20, 18, 16, 14, 12, 10, 8, 6, 4, 2 ppm, or less. In another aspect, the level of Ce present is less than about 10 ppm, for example, about 10, 9, 8, 7, 6, 5, 4, 3, 2, or 1 ppm, or less.

In yet another aspect, the presence of lattice defects in a rare earth phosphate, metal oxide, or a combination thereof, can result in a phosphor blend having a reduced brightness. For example, lattice defects created by non-stoichiometric synthesis of a rare earth phosphate can provide reduced brightness. In a specific aspect, a rare earth phosphate produced by direct firing of Gd2O₃ with DAP at less than about 1 phosphate ratio can result in a GdPO₄ having absorption in the UV and/or visible region, leading to reduced brightness when incorporated in a phosphor blend.

The present invention can be described in various non-limiting aspects, such as the following:

Aspect 1: A composition comprising one or more phosphor materials comprising (LaCeTb)PO₄ and a rare earth phosphate, a metal phosphate, a metal oxide, or a combination thereof.

Aspect 2: The composition of aspect 1, wherein the one or more phosphor materials comprises a green-emitting component.

Aspect 3: The composition of aspect 1, comprising wherein the rare earth phosphate comprises LaPO₄, GdPO₄, LuPO₄, (La₁₋ₓGdₓ)PO₄, or YPO₄, or a combination thereof.

Aspect 4: The composition of aspect 1, wherein the rare earth phosphate comprises GdPO₄.

Aspect 5: The composition of aspect 1, wherein the metal phosphate comprises BiPO₄, AlPO₄, or a combination thereof.

Aspect 6: The composition of aspect 1, wherein the metal oxide comprises Al₂O₃, Y₂O₃, La₂O₃, Ta₂O₅, Nb₂O₅, Gd₂O₃, or a combination thereof.

Aspect 7: The composition of aspect 1, having a reduced Tb content and an equivalent brightness, as compared to a comparable phosphor material not comprising a rare earth phosphate, metal phosphate, or metal oxide.

Aspect 8: The composition of aspect 1, wherein all or a portion of the one or more phosphor materials have an average particle size of from about 2 μm to about 16 μm.

Aspect 9: A lamp assembly comprising the composition of aspect 1.

Aspect 10: The lamp assembly of aspect 9, being a fluorescent lamp assembly, a compact fluorescent lamp assembly, or a combination thereof.

Aspect 11: The composition of aspect 1, wherein the composition comprises (La_{1-x-y-z}Gd_{z}CeₓTb_{y})PO₄; wherein:

a. 0.2<x<0.6;

b. 0.05<y<0.1; and

c. 0.2<z<0.6.

Aspect 12: A method for preparing one or more phosphor materials comprising (LaCeTb)PO₄ and a rare earth phosphate, a metal phosphate, a metal oxide, or a combination thereof.

Aspect 13: The method of aspect 12, wherein the one or more phosphor materials comprises a green-emitting component.

Aspect 14: The method of aspect 12, wherein the rare earth phosphate comprises LaPO₄, GdPO₄, LuPO₄, (La₁₋ₓGdₓ)PO₄, or YPO₄, or a combination thereof.

Aspect 15: The method of aspect 12, wherein the rare earth phosphate comprises GdPO₄.

Aspect 16: The method of aspect 12, wherein the metal phosphate comprises BiPO₄, AlPO₄, or a combination thereof.

Aspect 17: The method of aspect 12, wherein the metal oxide comprises Al₂O₃, Y₂O₃, La₂O₃, Ta₂O₅, Nb₂O₅, Gd₂O₃, or a combination thereof.

Aspect 18: The method of aspect 12, wherein the method comprises making a single phase comprising (La_{1-x-y-z}Gd_{z}CeₓTb_{y})PO₄; wherein:

a. 0.2<x<0.6;

b. 0.05<y<0.1; and

c. 0.2<z<0.6.

Aspect 19: A method for preparing a lamp assembly, the method comprising contacting a rare earth phosphate, a metal phosphate, a metal oxide, or a combination thereof; one or more phosphor materials comprising (LaCeTb)PO₄; and an interior surface of a lamp envelope.

Aspect 20: The method of aspect 19, wherein the rare earth phosphate, metal phosphate, metal oxide, or a combination thereof is first contacted with the interior surface of a lamp envelope to form a pre-coating.

Aspect 21: The composition of aspect 1, having at least about 5 wt. % less Tb than a conventional phosphor not comprising or contacted with a rare earth phosphate, a metal phosphate, a metal oxide, or a combination thereof.

Aspect 22: The composition of aspect 1, retaining at least about 96% brightness with a Tb content of about 3.5 wt. % or less, as compared to a conventional phosphor not comprising or contacted with a rare earth phosphate, a metal phosphate, a metal oxide, or a combination thereof.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Phosphor Materials

In a first example, samples of phosphor materials were prepared as detailed in Table 1, below, having varying Tb content. As detailed in Table 1, reduction in brightness and a shift in color coordinates occurred for the samples having reduced Tb content.

TABLE 1
Phosphor materials having reduced Tb content

| Tb | 5 microns Blend* | 8 microns Blend* | 5 microns single phase\hat{ } |
|---|---|---|---|
| wt % | % 100 hr lamp Brightness | | |
| 8.8 | 100 | 100 | 100 |
| 7.9 | 98 | 98 | 97 |
| 7.0 | 95 | 97 | 96 |
| 6.2 | 94 | 95 | 95 |
| 5.2 | 92 | 93 | 93 |
| 4.4 | 90 | 91 | 90 |

*Blend of ratioed (La_{0.45}Ce_{0.42}Tb_{0.13})PO₄—(La_{0.515}Ce_{0.42}Tb_{0.065})PO₄)
\hat{ }Single phase (La_{1-x-y}CeₓTb_{y})PO₄

The reduced Tb content was in the single phase LAP formulation (La_{0.45+x}Ce_{0.42}Tb_{0.13-x})PO₄ or was a blend of a lower Tb content material (La_{0.52}Ce_{0.42}Tb_{0.06})PO₄ with a higher Tb content material (La_{0.45}Ce_{0.42}Tb_{0.13})PO₄ resulted in significant brightness drop with no substantial difference between the single phase and blended materials. Blending of other high and low Tb or Ce LAP (e.g. (La_{0.4}Ce_{0.45}Tb_{0.15})PO₄−(La_{0.65}Ce_{0.30}Tb_{0.05})PO₄) likewise does not provide any apparent benefit.

Direct Blending with a Green Phosphor:

MPO₄ (M=Gd, La, Y, Lu, Al) was made from precipitation of MCl₃ (or metal nitrate) and (NH₄)₂HPO₄. The particle size was controlled by firing the resulting MPO₄ precipitate with flux level and/or firing temperature. Suitable particle size range was from about 2 microns to about 10 microns. The best result was from matching the particle size of the phosphor used in the blend. LAP phosphors of the formula (La_{1-x-y}CeₓTb_{y})PO₄ of particle size between 3 microns to 8 microns were used in this blend. In particular, a formulation (La_{0.45}Ce_{0.42}Tb_{0.13})PO₄ was utilized for the test, but Ce between the range of 0.2 to 0.5 mole fraction and Tb between 0.04 to 0.2 mole fraction was used as well. The LAP and MPO₄ were blended and ready to be used for fluorescent lamp applications.

MPO₄ (M=Gd, La, Y, Lu, Al) made as described above was blended with a CAT green phosphor of formulation (Ce₁₋ₓTbₓ)MgAl₁₁O₁₉ where x was between 0.25 to 0.5 mole fraction and had a particle size between 3 microns to 12 microns. The CAT and MPO₄ were blended and ready to be used in fluorescent lamp application.

MPO₄ (M=Gd, La, Y, Lu, Al) made as described above was blended with a CBT ((_{Gd1-x-y}CeₓTb_{y})MgB₅O₁₀) where x was between 0.2 to 0.3 and y between 0.12 to 0.2 mole fraction and particle size between 3 to 9 microns.

Metal oxides M₂O₃ (M=Gd, La, Y, Lu, Al) was be purchased or for M=Gd, La, Y and Lu, they were made from a precipitation of MCl₃ (or metal nitrate) and oxalic acid and fire/flux to the desired particle size generally between 2 to 10 microns. This was mixed and blended with a LAP as described above.

M₂O₃ (M=Gd, La, Y, Al, Lu) as described above was blended with a CAT as also described above.

M₂O₃ (M=Gd, La, Y, Al, Lu) as described above was blended with a CBT as also described above.

Flux and Firing with a Green Phosphor:

MPO₄ or M₂O₃ (M=Gd, La, Y, Lu, Al) of particle size range from 0.2 microns to 7 microns was mixed with a (La_{1-x-y}CeₓTb_{y})PO₄ phosphor, as described above, of particle size between 2 to 10 microns and fired with flux at 1,200° C. under reducing atmosphere (e.g. 5% H₂/95% N₂).

MPO₄ or M₂O₃ (M=Gd, La, Y, Lu, Al) of particle size range from 0.2 microns to 7 microns was mixed with a (Ce₁₋ₓTbₓ)MgAl₁₁O₁₉ phosphor, as described above, of particle size between 2 to 10 microns and fired with flux at 1,200° C. under reducing atmosphere (e.g. 5% H₂/95% N₂).

MPO₄ or M₂O₃ (M=Gd, La, Y, Lu, Al) of particle size range from 0.2 microns to 7 microns was mixed with a (Gd_{1-x-y}CeₓTb_{y})MgB₅O₁₀ phosphor, as described above, of particle size between 2 to 10 microns and fired with flux at 1,200° C. under reducing atmosphere (e.g. 5% H₂/95% N₂).

Flux and Firing with a Phosphor Co-Precipitate or Phosphor Precursor:

MPO₄ or M₂O₃ (M=Gd, La, Y, Lu, Al) of particle size range from 0.2 microns to 7 microns was mixed with a co-precipitate of (La_{1-x-y}CeₓTb_{y})PO₄ made from a solution of (La_{1-x-y}CeₓTb_{y})Cl₃ or nitrate with (NH₄)₂HPO₄ and fired with flux at 1, 200° C. under reducing atmosphere (e.g. 5% H₂/95% N₂) to targeted particle size.

A precipitate of MPO₄ (M=Gd, La, Y, Lu, Al) was made from a solution of MCl₃ (or nitrate) and (NH₄)₂HPO₄. The resulting precipitate after drying was mixed with a co-precipitate of (La_{1-x-y}CeₓTb_{y})PO₄ made from a solution of (La_{1-x-y}CeₓTb_{y})Cl₃ or nitrate with (NH₄)₂HPO₄. The blend was then fired with flux such as boric acid, lithium carbonate or lithium tetraborate at 1,200° C. in reducing atmosphere (5% H₂/95% N₂) to targeted particle size.

MPO₄ or M₂O₃ (M=Gd, La, Y, Lu, Al) powder of particle size about 2-4 microns was suspended in a solution. A co-precipitate of (La_{1-x-y}CeₓTb_{y})PO₄ was precipitated by adding a solution of (La_{1-x-y}CeₓTb_{y})Cl₃ (or nitrate) and (NH₄)₂HPO₄ to the suspension. The resulting mix precipitate was filtered, dried and fired with flux at 1,200° C. in reducing atmosphere to specific particle size (between 3 to 10 microns).

MPO₄ was precipitated from a solution of MCl₃ (or nitrate) and (NH₄)₂HPO₄ first, to the resulting suspension a co-precipitate of (La_{1-x-y}CeₓTb_{y})PO₄ was prepared next by adding a solution of (La_{1-x-y}CeₓTb_{y})Cl₃ (or nitrate) and (NH₄)₂HPO₄. The resulting mix precipitate was filtered, dried and fired with flux at 1,200° C. in reducing atmosphere to specific particle size (between 3 to 10 microns).

MPO₄ or M₂O₃ (M=Gd, La, Y, Lu, Al) of particle size range from 0.2 microns to 7 microns was mixed with a (Ce₁₋ₓTbₓ)MgAl₁₁O₁₉ or (Gd_{1-x-y}CeₓTb_{y})MgB₅O₁₀ phosphor and fired with flux at 1200-1600° C. for CAT and less than 1,200° C. for CBT under reducing atmosphere (e.g. 5% H₂/95% N₂) to targeted particle size.

A precipitate of MPO₄ (M=Gd, La, Y, Lu, Al) was made from a solution of MCl₃ (or nitrate) and (NH₄)₂HPO₄. The resulting precipitate after drying was mixed with a (Ce₁₋ₓTbₓ)MgAl₁₁O₁₉ or (Gd_{1-x-y}CeₓTb_{y})MgB₅O₁₀ phosphor and fired with flux at 1,200-1,600° C. for CAT and less than 1,200° C. for CBT under reducing atmosphere (e.g. 5% H₂/95% N₂) to targeted particle size.

A single phase (La_{1-x-y-z}Gd_{z}CeₓTb_{y})PO₄ at low Tb, (0.2<x<0.6; 0.05<y<0.1; 0.2<z<0.6) was made.

A solution of (NH₄)₂HPO₄ was added to a solution of (La_{1-x-y-z}Gd_{z}CeₓTb_{y})Cl₃ or nitrate made from the formula specified ratio of La₂O₃, Gd₂O₃, Tb₄O₂, Ce(NO₃)₃.xH₂O dissolved in either HCl or HNO₃. Co-precipitation of the (La_{1-x-y-z}Gd_{z}CeₓTb_{y})PO₄ resulted from the mixing of the two solutions. The resulting (La_{1-x-y-z}Gd_{z}CeₓTb_{y})PO₄ co-precipitate was filtered, dried. The dried co-precipitate was flux (H₃BO₃/Li₂CO₃ or Li₂B₄O₇) and fired at 1,200° C. in reducing atmosphere (5% H₂/95% N₂) to targeted particle size.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A composition comprising one or more phosphor materials comprising (LaCeTb)PO₄ and a rare earth phosphate, a metal phosphate, a metal oxide, or a combination thereof.

2. The composition of claim 1, wherein the one or more phosphor materials comprises a green-emitting component.

3. The composition of claim 1, comprising wherein the rare earth phosphate comprises LaPO₄, GdPO₄, LuPO₄, (La₁₋ₓGdₓ)PO₄, or YPO₄, or a combination thereof.

4. The composition of claim 1, wherein the rare earth phosphate comprises GdPO₄.

5. The composition of claim 1, wherein the metal phosphate comprises BiPO₄, AlPO₄, or a combination thereof.

6. The composition of claim 1, wherein the metal oxide comprises Al₂O₃, Y₂O₃, La₂O₃, Ta₂O₅, Nb₂O₅, Gd₂O₃, or a combination thereof.

7. The composition of claim 1, having a reduced Tb content and an equivalent brightness, as compared to a comparable phosphor material not comprising a rare earth phosphate, metal phosphate, or metal oxide.

8. The composition of claim 1, wherein all or a portion of the one or more phosphor materials have an average particle size of from about 2 μm to about 16 μm.

9. A lamp assembly comprising the composition of claim 1.

10. The lamp assembly of claim 17, being a fluorescent lamp assembly, a compact fluorescent lamp assembly, or a combination thereof.

11. The composition of claim 1, wherein the composition comprises (La_{1-x-y-z}Gd_{z}CeₓTb_{y})PO₄; wherein:
a. 0.2<x<0.6;
b. 0.05<y<0.1; and
c. 0.2<z<0.6.

12. A method for preparing one or more phosphor materials comprising (LaCeTb)PO₄ and a rare earth phosphate, a metal phosphate, a metal oxide, or a combination thereof.

13. The method of claim 12, wherein the one or more phosphor materials comprises a green-emitting component.

14. The method of claim 12, wherein the rare earth phosphate comprises LaPO₄, GdPO₄, LuPO₄, (La₁₋ₓGdₓ)PO₄, or YPO₄, or a combination thereof.

15. The method of claim 12, wherein the rare earth phosphate comprises GdPO₄.

16. The method of claim 12, wherein the metal phosphate comprises BiPO₄, AlPO₄, or a combination thereof.

17. The method of claim 12, wherein the metal oxide comprises Al₂O₃, Y₂O₃, La₂O₃, Ta₂O₅, Nb₂O₅, Gd₂O₃, or a combination thereof.

18. The method of claim 12, wherein the method comprises making a single phase comprising (La_{1-x-y-z}Gd_{z}CeₓTb_{y})PO₄; wherein:
a. 0.2<x<0.6;
b. 0.05<y<0.1; and
c. 0.2<z<0.6.

19. A method for preparing a lamp assembly, the method comprising contacting a rare earth phosphate, a metal phosphate, a metal oxide, or a combination thereof; one or more phosphor materials comprising (LaCeTb)PO₄; and an interior surface of a lamp envelope.

20. The method of claim 19, wherein the rare earth phosphate, metal phosphate, metal oxide, or a combination thereof is first contacted with the interior surface of a lamp envelope to form a pre-coating.

21. The composition of claim 1, having at least about 5 wt. % less Tb than a conventional phosphor not comprising or contacted with a rare earth phosphate, a metal phosphate, a metal oxide, or a combination thereof.

22. The composition of claim 1, retaining at least about 96% brightness with a Tb content of about 3.5 wt. % or less, as compared to a conventional phosphor not comprising or contacted with a rare earth phosphate, a metal phosphate, a metal oxide, or a combination thereof.
